(19) United States
(12) Patent Application Publication
(10) Pub. No.: US 2014/0083815 A1
(43) Pub. Date: Mar. 27, 2014

(54) VALUABLE PAPER POSITION CORRECTION METHOD

(71) Applicant: INTERNATIONAL CURRENCY TECHNOLOGIES CORPORATION, (US)

(72) Inventors: Chia-Min CHANG, Taipei (TW); Wei CHIU, Taipei (TW); Ming-Feng TSOU, Taipei (TW); Ming-Hua TSOU, Taipei (TW)

(73) Assignee: INTERNATIONAL CURRENCY TECHNOLOGIES CORPORATION, Taipei (TW)

(21) Appl. No.: 13/800,927

(22) Filed: Mar. 13, 2013

(30) Foreign Application Priority Data
Sep. 25, 2012 (TW) 101135135
Dec. 21, 2012 (TW) 101149061

(51) Int. Cl. G07F 7/04

(52) U.S. Cl. CPC G07F 7/04
USPC 194/344

(57) ABSTRACT

A valuable paper position correction method for correcting an offset valuable paper includes the step of enabling two sensors of a sensor unit to sense the presence of the valuable paper, the step of determining the time span between the detection of the sensors, the step of calculating the difference in distance between the two bill-transfer roller sets using the detected data of the time span and the revolving speeds of motors, the step of calculating the length of time needed for speed change, the step of controlling one of the motors to change its speed in driving the respective bill-transfer roller set, and the step of controlling the speeded up or slowed down motor to return to its former speed after the length of time for speed change is up.

This application claims the priority benefit of Taiwan patent applications number 101135135 and 101149061, filed on Sep. 25, 2012 and Dec. 21, 2012.

### BACKGROUND OF THE INVENTION

1. Field of the Invention

The present invention relates to bill acceptor technology and more particularly, to a valuable paper position correction method for use in a bill acceptor to automatically correct the position of an offset valuable paper.

2. Description of the Related Art

Following fast development of modern technology, convenience and rapidness have become important factors in our modern daily life. Nowadays, different automatic vending machines, card dispensers, ticket machines and bill exchange machines are used everywhere to sell different products without serviceman. These machines are highly appreciated for the advantage of saving much labor and bringing convenience to people.

Further, to avoid direct loss due to counterfeiting and to avoid inadvertently passing counterfeit valuable papers to consumers, a bill acceptor has recognition means to recognize the authenticity of a valuable paper before receiving it. However, the bill passage of a bill acceptor is specifically designed for a particular valuable paper of one specific width. Because different valuable papers issued from different countries have different sizes (length, width and thickness) and different anti counterfeit characteristics at different locations. A valuable paper that is inserted into a bill acceptor must be kept in accurate alignment with the recognition device, so that the recognition device can accurately recognize the anti-counterfeit characteristics. If a valuable paper is inserted into a bill acceptor in an offset manner, the recognition device of the bill acceptor may reject the valuable paper due to a recognition error. In this case, the user must insert the valuable paper again, causing inconvenience.

Further, many valuable paper position correction designs have been created for use in a bill acceptor for correcting an offset valuable paper. A known valuable paper position correction design uses two clamping arms at two opposite lateral sides of the bill passage for correcting the position of an offset valuable paper being transferred by transmission roller sets, and sensors to detect a feedback resistance between the valuable paper and the clamping arms. When the resistance reaches a predetermined value, the clamping arms are stopped. However, a valuable paper may wrinkle or curve after a long use. If the two clamping arms clamp a wrinkled or curved valuable paper, a feedback resistance cannot be accurately produced, resulting in a detection error. When this problem occurs, the valuable paper can be jammed between the clamping arms. Further, this valuable paper position correction design has a complicated structure, leading to a high manufacturing cost.

Therefore, it is desirable to provide a valuable paper position correction means that eliminates the aforesaid problems.

### SUMMARY OF THE INVENTION

The present invention has been accomplished under the circumstances in view. It is therefore one object of the present invention to provide a valuable paper position correction method, which automatically corrects an offset valuable paper without using any extra mechanical correcting mechanism, preventing mechanical wear, reducing the cost and simplifying the operation.

The valuable paper position correction method is used in a bill acceptor. When a valuable paper is inserted into the bill slot of the bill acceptor, two motors will be triggered to drive respective bill-transfer roller sets respectively. At this time, two sensor components of a sensor unit sense the presence of the inserted valuable paper. Subject to the sensing operation of the sensor components, the sensor unit determines the time span between the detection of two sensors and calculates the difference in distance between the two bill-transfer roller sets using the detected data of the time span and the revolving speeds of the motors. Thereafter, the sensor unit calculates the length of time needed for speed change, and then controls one of the motor to change its speed in driving the respective bill-transfer roller set, and then controls the speeded up or slowed down motor to return to its former speed after the length of time for speed change is up. Thus, the valuable paper position correction method can accurately correct an offset Valuable paper to the range within 4° relative to the accurate center position, facilitating further valuable paper validation and collection procedures.

### BRIEF DESCRIPTION OF THE DRAWINGS

FIG. 1 is a flow chart of a valuable paper position correction method in accordance with the present invention.

FIG. 2 is an elevational view of a bill acceptor using the valuable paper position correction method in accordance with the present invention.

FIG. 3 is an exploded view of the bill acceptor shown in FIG. 2.

FIG. 4 is an exploded view of the bill-receiving unit of the bill acceptor shown in FIG. 2 (the bill box excluded).

FIG. 5 is another exploded view of the bill acceptor shown in FIG. 2.

FIG. 6 is a sectional side view of the bill acceptor shown in FIG. 2.

FIG. 7 is a schematic top view of the present invention, illustrating a valuable paper inserted into the bill slot and the transmission mechanism started.

FIG. 8 is a schematic top view of the present invention, illustrating the valuable paper deviated from the course.

FIG. 9 is a schematic top view of the present invention, illustrating a valuable paper position correction status.

FIG. 10 corresponds to FIG. 9, illustrating the position of the inserted valuable paper corrected.

FIG. 11 is a test data table of the present invention (I).

FIG. 12 is a test data table of the present invention (II).

FIG. 13 is an angle-centimeter conversion diagram obtained before correction according to the present invention.

### DETAILED DESCRIPTION OF THE PREFERRED EMBODIMENT

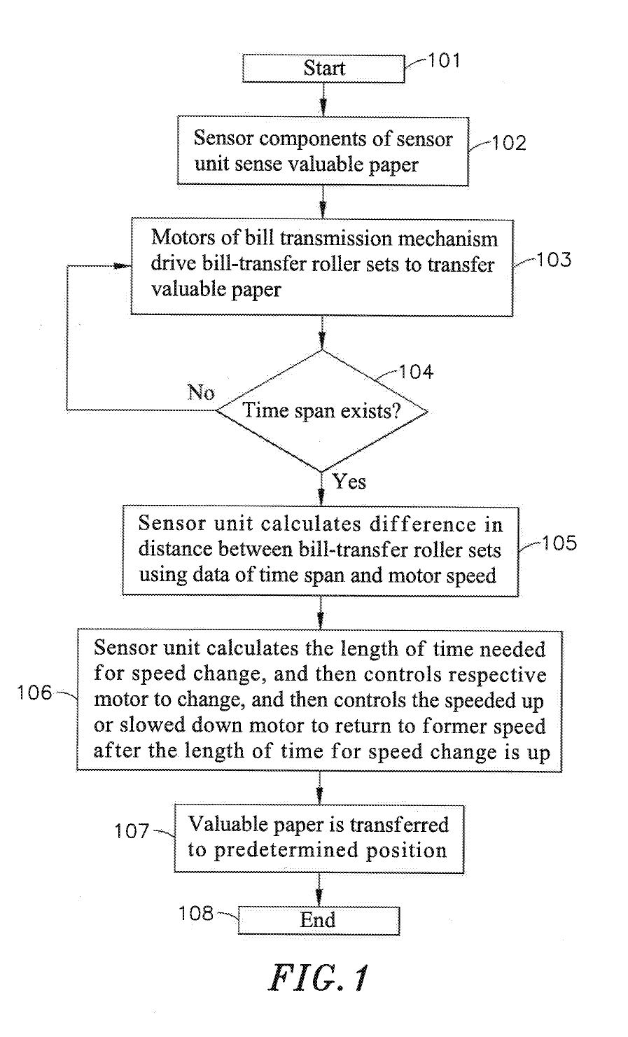

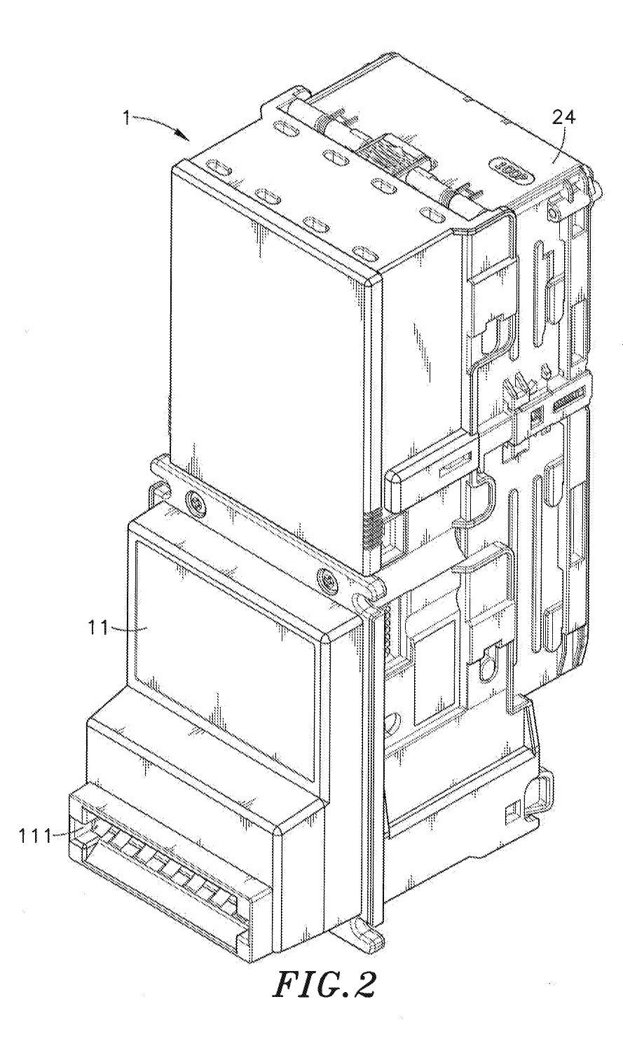

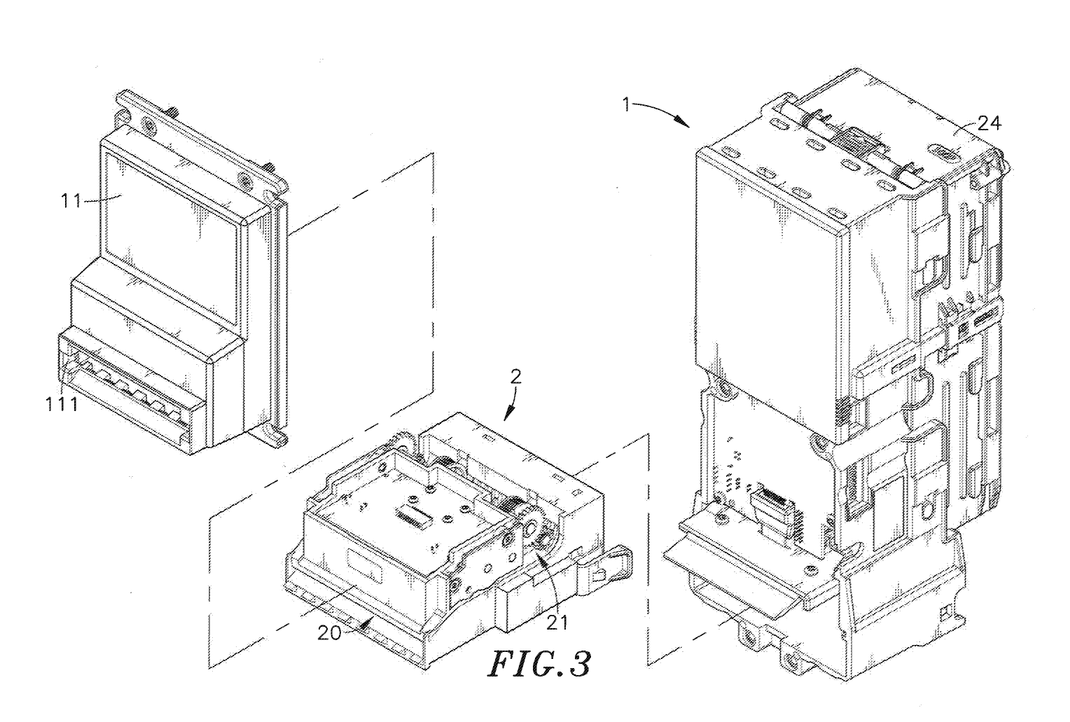

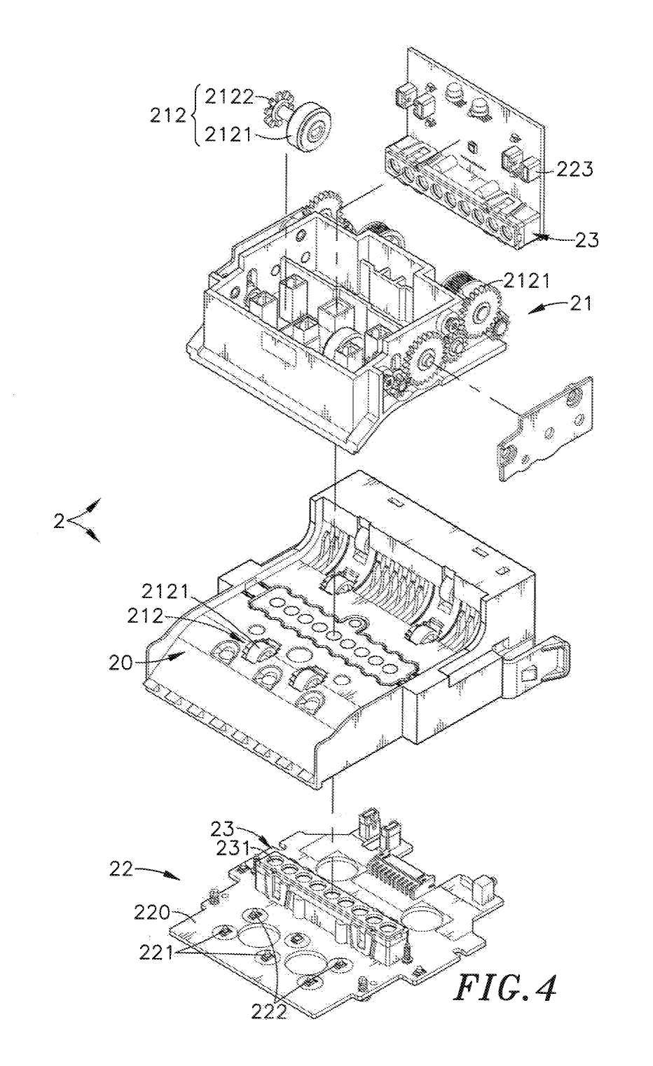

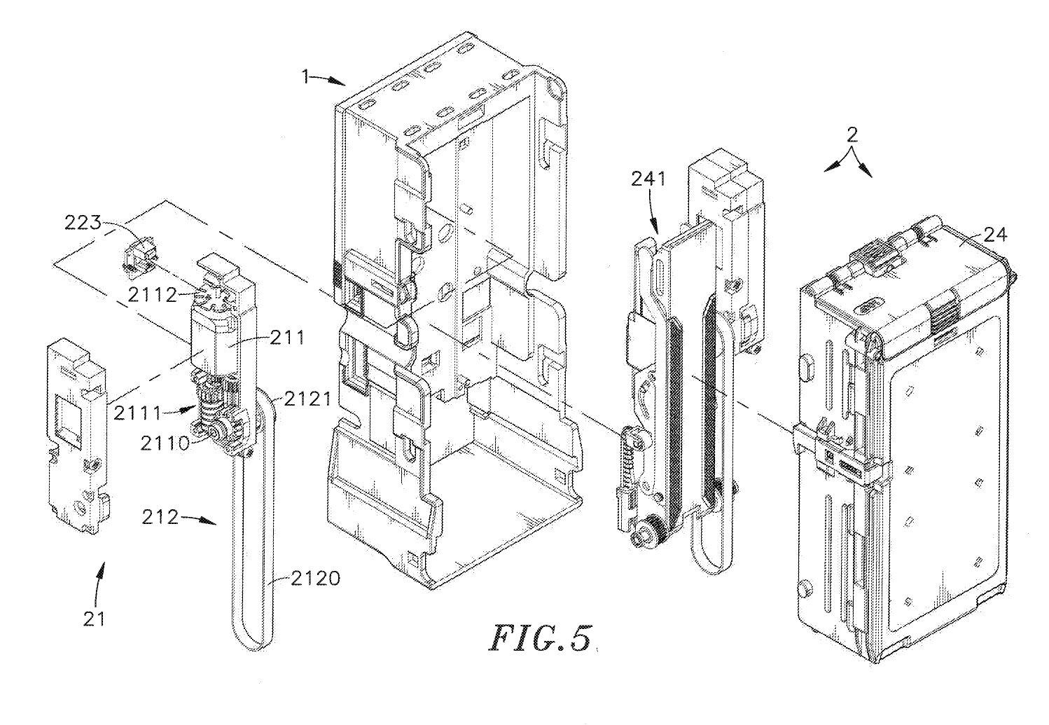

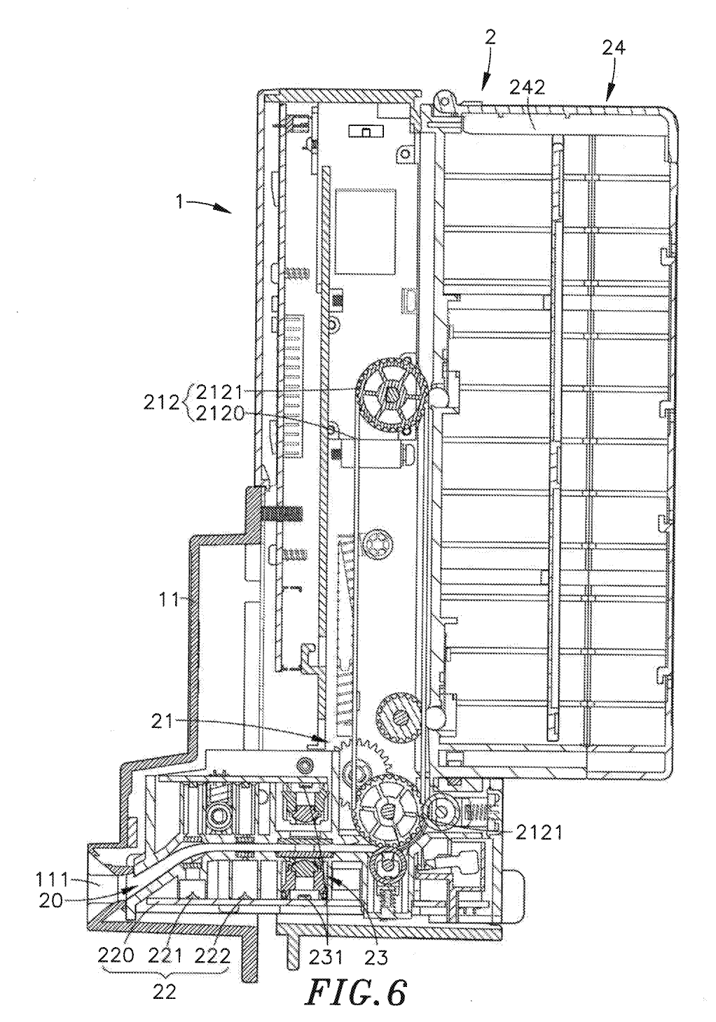

Referring to FIGS. 1-6, a bill acceptor is shown comprising a housing 1, and a bill-receiving unit 2. The housing 1 comprises a face panel 11 defining a bill slot 111. The bill-receiving unit 2 is accommodated in the housing 1, defining a bill passage 20 in communication with the bill slot 111 of the housing 1.

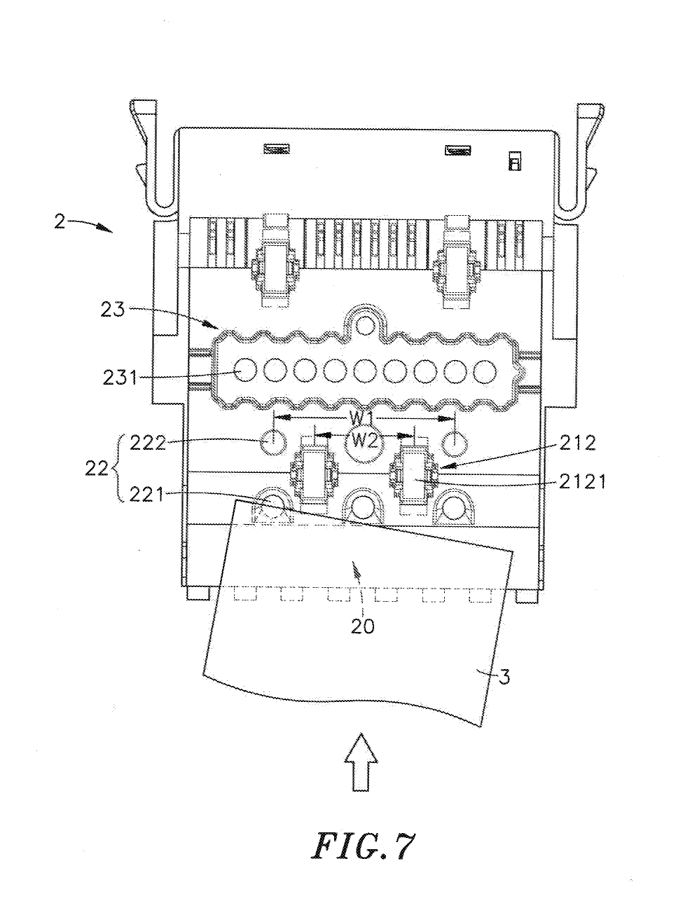

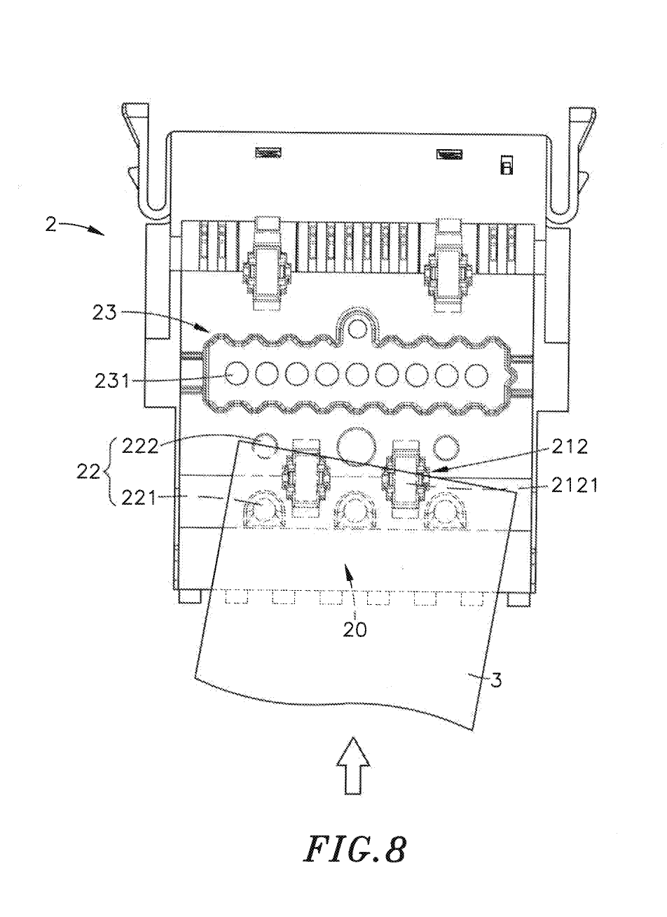

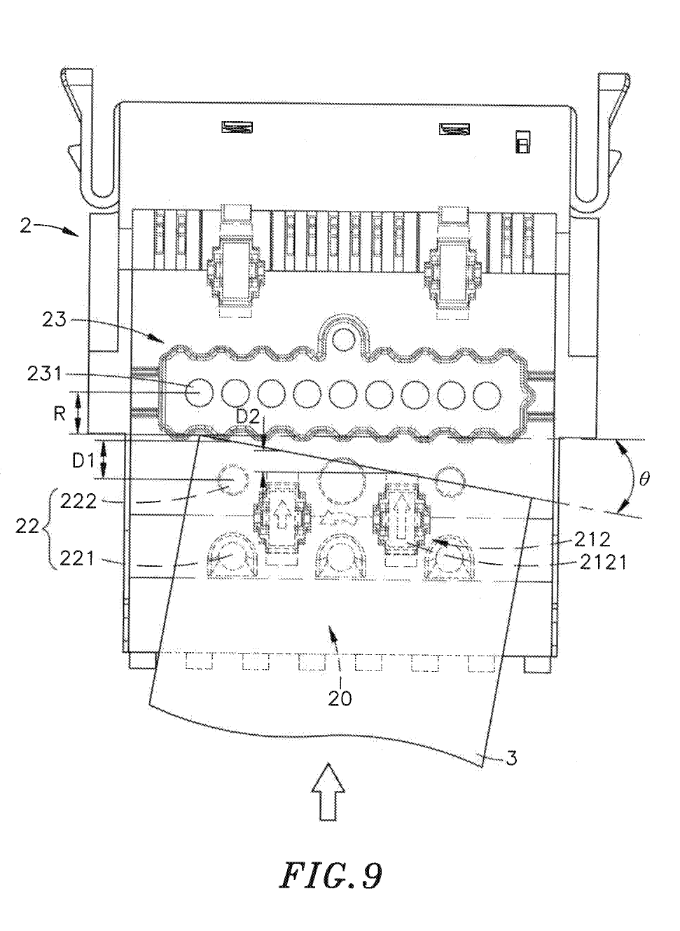

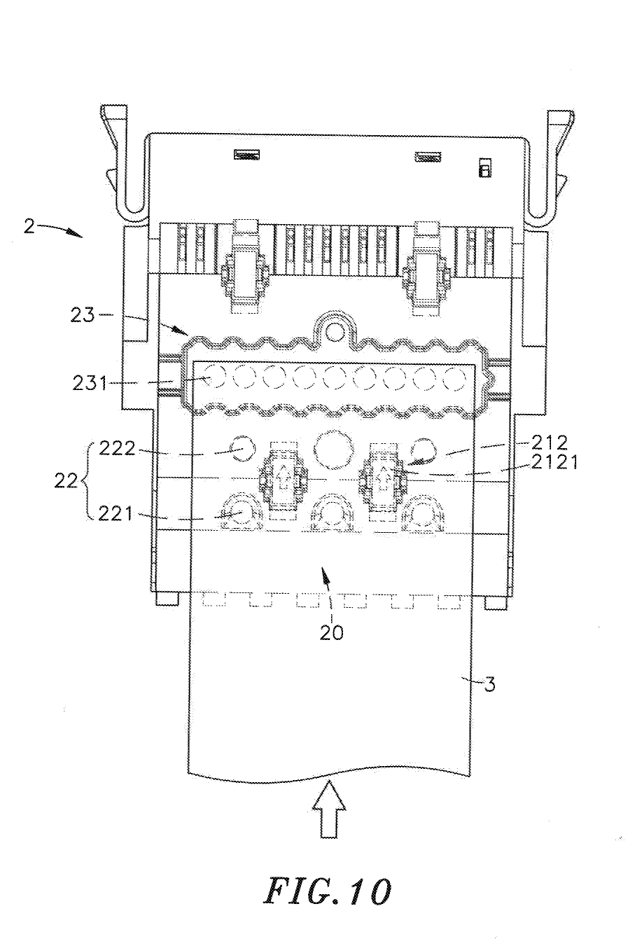

Further, the bill-receiving unit 2 comprises a bill transmission mechanism 21, a sensor unit 22, a bill validation unit 23, and a bill box 24. The bill transmission mechanism 21, the sensor unit 22 and the bill validation unit 23 are installed in the bill passage 20. The bill box 24 is located at the rear side of the bill passage 20 remote from the bill slot 111. The bill transmission mechanism 21 comprises two motors 211, two transmission gear sets 2111 respectively coupled to the motors 211 at one side and rotatable by the respective motors 211, two bill-transfer roller sets 212 respectively coupled to respective output shafts 2110 of the transmission gear sets 2111, and two encoder wheels 2112 respectively coupled to the motors 211 opposite to the transmission gear sets 2111 and rotatable by the respective motors 211. Each bill-transfer roller set 212 comprises a plurality of rollers 2121, a transmission belt 2120 mounted around the rollers 2121, and an encoder wheel 2122 mounted at the roller shaft of one roller 2121 that is disposed near the front opening of the bill passage 20. The encoder wheel 2122 has photo gaps equiangularly spaced around the border thereof. The sensor unit 22 comprises a control circuit 220, and a plurality of, for example, a plurality of transversely spaced sensor components 221, two sensors 222 and two transversely spaced photo interrupters 223 for sensing the passing of each inserted valuable paper 3 (see FIGS. 7-10) and controlling the operation of the bill transmission mechanism 21 to transfer or release the valuable paper 3.

During operation of the motors 211, the photo interrupters 223 drive light source means thereof (not shown) to emit light toward the encoder wheels 2112 and photo receptor means thereof (not shown) to convert the light pulse from the encoder wheels 2112 into a pulse current and to output the pulse current to microprocessor means (not shown) of the control circuit 220 for calculating the revolving speed of the respective motors 211. The microprocessor means of the control circuit 220 also calculates the time span between the detection of the two sensors 222 that sensed the valuable paper 3, and then multiplies the revolving speeds of the motors 211 by the time span to get the difference of input direction between the two transversely spaced sensors 222. Similarly, the photo interrupters 223 of the sensor unit 22 can detect the amount of rotation of the rollers 2121 of the bill-transfer roller sets 212 by means of measuring the rotated number of photo gaps of the respective encoder wheels 2122. Subject to the pulse signal generated by the encoder wheels 2122, the difference in distance in which the valuable paper 3 passed through the two sensors 222 is calculated.

Further, the sensor unit 22 calculates the difference in distance between the two bill-transfer roller sets 212=the difference in input direction between the two sensors 222×(the driving distance of the rollers 2121 of the two bill-transfer roller sets 212/the transverse distance between the two sensors 222), enabling the proportional-integral-derivative (PID) controller of the control circuit 220 to drive one of the motors 211 to reduce or accelerate the speed. The change in speed of the respective motor 211 in a unit time subject to a predetermined ratio is a constant value. Thus, the speed change time period required for the respective motor 211 can be obtained by: the difference in distance between the two bill-transfer roller sets 212/the change in speed of the respective motor 211. Because the controller gives PWM (pulse width modulation) output for the feedback control of the output of the motors 211, the speed of the motors 211 can be maintained constant.

Further, the detected data regarding the inserted valuable paper 3 can be transmitted to the control circuit 220 or an external electronic device (computer or notebook) for calculating the input angle of the inserted valuable paper 3 to be arcTan (the difference in input direction between the two sensors 222/the transverse distance between the sensors 222). With respect to how the sensor unit 22 uses the sensors 222 and photo interrupters 223 to detect the time span of the passing of the inserted valuable paper 3 and the revolving speeds of the motors 211 and how the sensor unit 22 controls the motors 211 to drive the bill-transfer roller sets 212 in carrying the inserted valuable paper 3, all these procedures are of the known art and not within the scope of the spirit of the present invention, and therefore no further detailed description in the regard will be necessary.

The invention provides a valuable paper position correction method that can be used in the aforesaid bill acceptor. In actual application, this valuable paper position correction method can also be applied to an automatic vending machine, game console, or any consumer system that sells commodities or provides services. The aforesaid bill acceptor can also be used in any automatic vending machine, game console or consumer system. During application, the housing 1 of the bill acceptor is mounted in the housing of the automatic vending machine, game console or consumer system. After installation, the bill-receiving unit 2 is electrically connected to the control circuit of the automatic vending machine, game console or consumer system. During operation of the automatic vending machine, game console or consumer system, the bill validation unit 23 can validate the authenticity and value of each inserted valuable paper 3 (that can be a banknote, bill of exchange, stock share, certificate of ownership, coupon ticket, coupon, ID card, vehicle license, driving license, passport or any other security certificate).

The valuable paper position correction method is performed subject to the following procedure:
(101) Start.
(102) The sensor components 221 of the sensor unit 22 sense the insertion of a valuable paper 3 into the bill passage 20.
(103) The motors 211 of the bill transmission mechanism 21 are started to drive the bill-transfer roller sets 212, transferring the inserted valuable paper 3 forwards.
(104) The sensor unit 22 determines, subject to the detection of the sensors 222, whether or not there is a time span between the detection of the sensor components 22. Then return to step (103) if negative, or proceed to step (105) if positive.
(105) The sensor unit 22 calculates, subject to the detection results of the sensors 222, the difference in distance between the two bill-transfer roller sets 212 using the detected data of the time span between the detection of the two sensors 222 and the revolving speeds of the motors 211.
(106) The sensor unit 22 calculates the length of time needed for speed change, and then controls one of the motors 211 of the bill transmission mechanism 21 to change its speed in driving the respective bill-transfer roller set 212, and then controls the speeded up or slowed down motor 211 to return to its former speed after the length of time for speed change is up, thereby transferring the valuable paper 3 in the correct angle.
(107) The valuable paper 3 is transferred to the predetermined position.
(108) End the procedure.

As stated above, when a user inserts a valuable paper 3 through the bill slot 111 of the face panel 11 of the housing 1 into the bill passage 20 of the bill-receiving unit 2, the valuable paper 3 will be detected by one sensor component 221 of the sensor unit 22, and the sensor unit 22 will immediately drive the motors 211 of the bill transmission mechanism 21 to rotate the rollers 2121 of the bill-transfer roller sets 212 synchronously, carrying the valuable paper 3 to the bill validation unit 23, which will then validate the authenticity and value of the valuable paper 3.

If these two transversely spaced sensors 222 of the sensor unit 22 detect the presence of the valuable paper 3 at the same time, it means the valuable paper 3 is in or approximately in the center position. Under this condition, the sensor unit 22 drives the two motors 211 of the bill transmission mechanism 21 to rotate the bill-transfer roller sets 212, carrying the valuable paper 3 to a predetermined position in the bill passage 20 where a sampling and recognition module 231 of the bill validation unit 23 will validate the authenticity and value of the valuable paper 3. If the valuable paper 3 is recognized as a true valuable paper, the sensor unit 22 will drive the bill transmission mechanism 21 to carry the valuable paper 3 to the bill box 24 where a bill-pressing mechanism 241 of the bill box 24 will press the valuable paper 3 into the box body 242 of the bill box 24. If the valuable paper 3 is recognized as a counterfeit, the sensor unit 22 will drive the bill transmission mechanism 21 to carry the valuable paper 3 backwardly to the bill slot 111 of the face panel 11.

Referring to FIGS. 7-10, if a user inserts a valuable paper 3 into the bill slot 111 in a left offset or right offset manner, the valuable paper 3 will not touch the two transversely spaced sensors 222 of the sensor unit 22 at the same time. When the motors 211 of the bill transmission mechanism 21 drive the respective bill-transfer roller sets 212 to transfer the valuable paper 3 at this time, the front edge of the valuable paper 3 will touch one of the sensors 222 of the sensor unit 22. Immediately after the front edge of the valuable paper 3 triggers the other sensor 222, the control circuit 220 calculates the difference in distance D1 between the input direction of the valuable paper 3 sensed by the two sensors 222 by: multiplying the time difference between the time point the two sensors 222 sensed the valuable paper 3 by the revolving speed of the motors 211. Thus, the control circuit 220 can calculate the offset angle of the valuable paper 3 subject to arcTan (the difference in distance D1 between the input direction of the valuable paper 3 sensed by the two sensors 222/the transverse distance W1 between the two sensors 222).

Thereafter, calculate the difference in distance D2 between the two bill-transfer roller sets 212 of the bill transmission mechanism 21 to be: the difference in distance D1 between the input direction of the valuable paper 3 sensed by the two sensors 222 multiply (the transverse distance W2 between the rollers 2121 of the two bill-transfer roller sets 212/the transverse distance W1 between the two sensors 221). Thus, the control circuit 220 drives one motor 211 of the bill transmission mechanism 21 to reduce or accelerate the speed subject to the difference in distance D2 between the two bill-transfer roller sets 212 of the bill transmission mechanism 21. Thus, the speed change time period required for the respective motor 211 can be obtained by: the difference in distance between the two bill-transfer roller sets 212/the change in speed of the motor 211. Thereafter, the control circuit 220 controls the slowed down or speeded up motor 211 to change its speed in driving the respective bill-transfer roller set 212, and then to return to its former speed after the calculated length of time for speed change is up, thereby correcting the angular position of the valuable paper 3 to the center position. Subject to the application of the valuable paper position correction method, the bill acceptor does not need to use a complicated mechanical mechanism for correcting the position of an inserted valuable paper, preventing mechanical wear, reducing the cost and simplifying the operation.

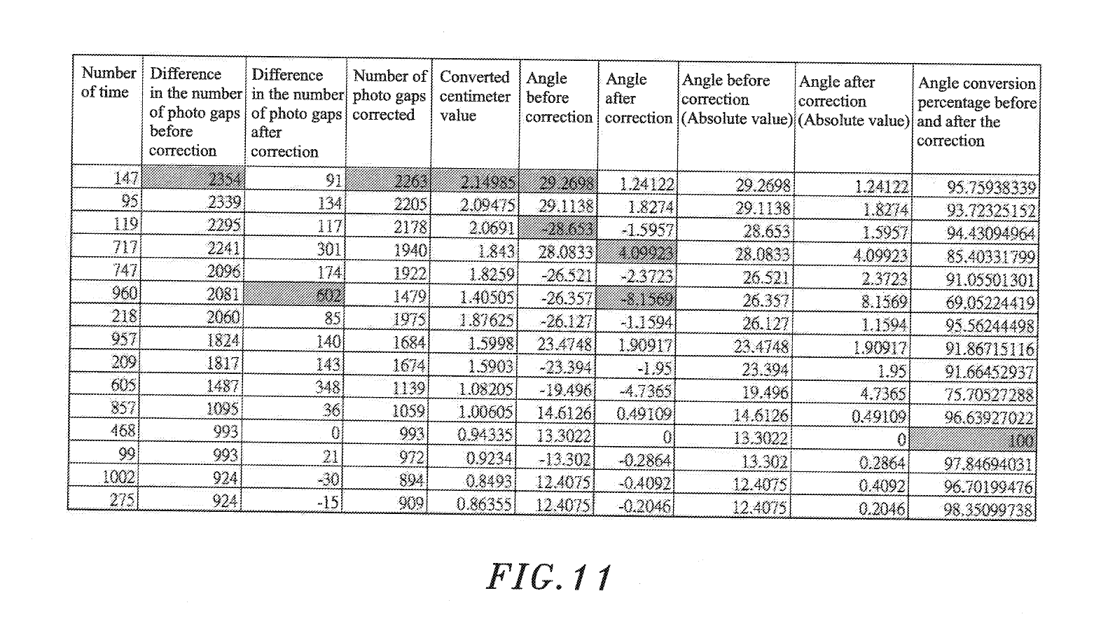

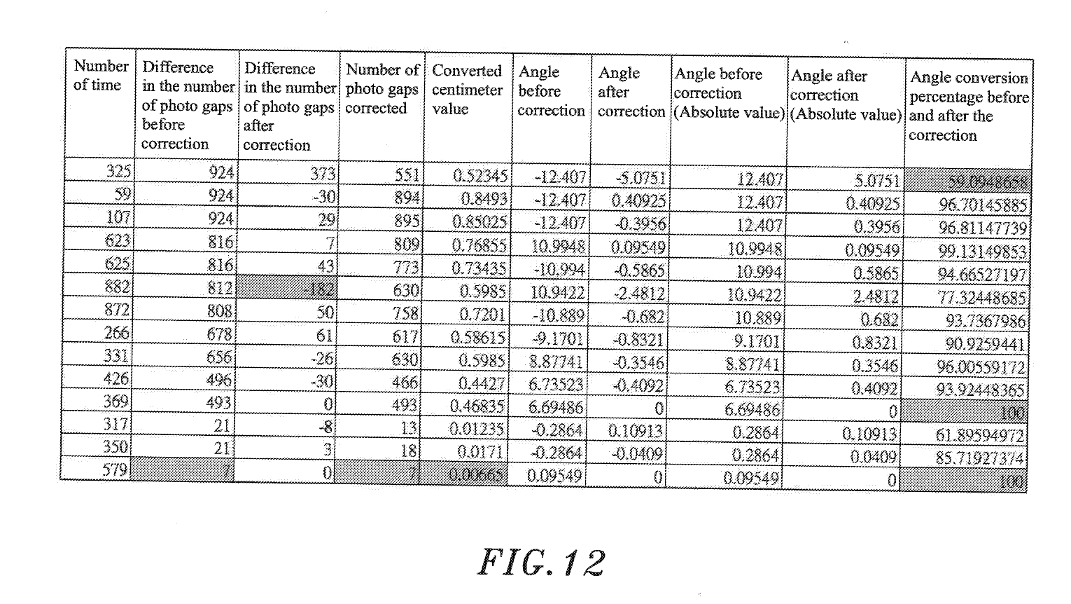

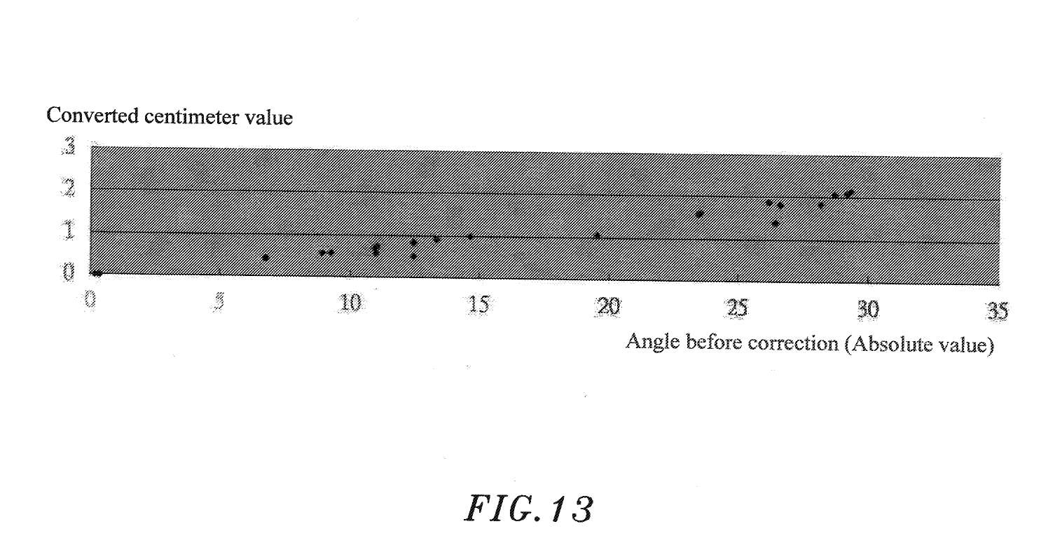

Referring to FIGS. 11-13, test data tables and angle-centimeter conversion diagram are provided to support the principle of the present invention. When the motors 211 of the bill transmission mechanism 21 drive the bill-transfer roller sets 212 to transfer the inserted valuable paper 3, the photo interrupters 223 of the sensor unit 22 count the number of photo gaps of the respective encoder wheels 2112 to measure the revolving speed of the respective motors 211, and the difference in distance D1 between the input direction of the valuable paper 3 sensed by the two sensors 222 is calculated by multiplying the time difference between the time point the two sensors 222 sensed the valuable paper 3 by the revolving speed of the motors 211. In actual practice, the photo interrupters 223 of the sensor unit 22 can directly detect the difference in photo gaps of the encoder wheels 2122 of the rollers 2121 before correction to be in the range of 7-2354. Subject to the pulse signal transmitted by the encoder wheels 2122, difference in distance D1 between the input direction of the valuable paper 3 can be figured out directly.

Further, subject to arcTan (the difference in distance D1 between the input direction of the valuable paper 3 sensed by the two sensors 222/the transverse distance W1 between the two sensors 222), the sensor unit 22 can figure out the uncorrected angle θ of the valuable paper 3 to be in the range of −28.653-29.2698. Subject to the relationship of trigonometric function between the width of the valuable paper 3 and the uncorrected angle θ of the valuable paper 3, the required difference R in which the two bill-transfer roller sets 212 correctly carry the valuable paper 3 to the bill validation unit 23 is calculated to be in the range of 0.00665-2.14985 cm.

Thereafter, the revolving speed of one motor 211 of the bill transmission mechanism 21 is reduced or accelerated. After a predetermined ratio in speed difference between the two motors 211 occurs, the speed change time period required for controlling the motors 211 to drive the respective bill-transfer roller sets 212 can then be figured out. For example, in every time unit of 1 ms, the sensor unit 22 of the bill-receiving unit 2 detects the difference in distance between the two bill-transfer roller sets 212, and controls one motor 211 to reduce the speed or the other motor 211 to accelerate the speed subject to a predetermined ratio (for example, 2:1, 3:1, or 5:1). When the length of time needed for speed change is up, the moving angle of the valuable paper 3 is corrected and kept in parallel to the bill passage 20. After correction, the difference in the number of photo gaps of the bill-receiving unit 2 is in the range of −182-602, the difference in angle is in the range of −8.1569-4.09923, the angle conversion percentage before and after the correction is in the range of 59.0948658-400. Thus, it can be seen that the valuable paper position correction method can accurately correct the input angle of the inserted valuable paper 3 to the range within 4° relative to the center position, facilitating the bill validation unit 23 to validate the valuable paper 3 and the bill box 24 to collect the valuable paper 3 accurately.

Although a particular embodiment of the invention has been described in detail for purposes of illustration, various modifications and enhancements may be made without departing from the spirit and scope of the invention. Accordingly, the invention is not to be limited except as by the appended claims.

1. A valuable paper position correction method used in a bill acceptor comprising a housing defining a bill slot for the insertion of a valuable paper and a bill-receiving unit accommodated in said housing, said bill-receiving unit comprising a bill box for collection said valuable paper, a bill transmission mechanism comprising two transversely spaced motors and two transversely spaced bill-transfer roller sets and adapted for transferring said valuable paper from said bill slot to said bill box, a sensor unit comprising two transversely spaced sensor components and adapted for sensing said valuable paper and controlling the operation of said bill transmission mechanism and two sensors, and a bill validation unit for validating the authenticity and value of said valuable paper, the valuable paper position correction method comprising the steps of:
(a) starting up said bill acceptor;
(b) enabling said sensor components of said sensor unit to sense the insertion of a valuable paper into said bill passage;
(c) enabling said motors of said bill transmission mechanism to drive said bill-transfer roller sets in transferring the inserted valuable paper forwards;
(d) enabling said sensor unit to determine the presence of a time span between the detection of said two sensors, and then returning to step (c) if negative, or proceeding to step (e) if positive;
(e) enabling said sensor unit to calculate the difference in distance between said two bill-transfer roller sets using the detected data of the time span between the detection of said two sensors and the revolving speeds of said motors;
(f) enabling said sensor unit to calculate the length of time needed for speed change, and then controlling one of said motors of said bill transmission mechanism to change the speed by speeding up or slowing down said one of said motors in driving the corresponding one of said bill-transfer roller sets, and then controlling the speeded up or slowed down said one of said motors to return to the former speed after the length of time for speed change is up, thereby transferring the valuable paper in the correct angle;
(g) transferring the valuable paper to the predetermined position; and
(h) ending the procedure.

2. The valuable paper position correction method as claimed in claim 1, wherein
said bill transmission mechanism further comprises two transmission gear sets respectively coupled to said motors at one side for rotating said bill-transfer roller sets respectively, and two encoder wheels respectively coupled to said motors at an opposite side for generating a respective series of light pulses upon rotation of said motors; and
said sensor unit further comprises a control circuit for controlling the operation of said sensor components and photo interrupters electrically connected to said control circuit and respectively arranged corresponding to said sensor components to detect the respective series of light pulses generated by said encoder wheels.

3. The valuable paper position correction method as claimed in claim 2, wherein said photo-interrupters are adapted to emit light toward said encoder wheels, to convert the light pulse from said encoder wheels into a pulse current, to output the pulse current to said control circuit for calculating the revolving speed of said motors, to calculate the time span between the detection of said sensors, to calculate the difference of input direction between said sensors by multiplying the revolving speeds of said motors by the time span, to calculate the difference in distance between said bill-transfer roller sets, and to control one said motor to change the speed subject to the calculated data.

4. The valuable paper position correction method as claimed in claim 3, wherein the difference in distance between said bill-transfer roller sets is equal to the difference in input direction between said two sensors multiply.

5. The valuable paper position correction method as claimed in claim 2, wherein
each of said bill-transfer roller sets further comprises an encoder wheel mounted at a roller shaft of one roller thereof that is disposed near a front opening of said bill passage, the encoder wheel of each of said bill-transfer roller sets defining a plurality of photo gaps equiangularly spaced around the border thereof; and
said sensor unit further comprises a plurality of photo interrupters electrically connected to said control circuit and adapted to detect pulse signals generated by the encoder wheels of said bill-transfer roller set upon rotation of said rollers for calculating the difference in distance between the input direction of said valuable paper sensed by said sensors.

6. The valuable paper position correction method as claimed in claim 1, wherein the speed change time period required for the respective said motor is obtained by: the difference in distance between said bill-transfer roller sets/the change in speed of the respective said motor.
